(19) United States
(12) Patent Application Publication
(10) Pub. No.: US 2024/0392076 A1
(43) Pub. Date: Nov. 28, 2024

(54) FOAM PRECURSOR WITH HIGH AMYLOSE STARCH AND METHODS THEREOF

(71) Applicant: Cruz Foam, Inc., Santa Cruz, CA (US)

(72) Inventors: William Thomas Lewczyk, Santa Cruz, CA (US); Juan Manuel Bravo, Santa Cruz, CA (US); John Selberg, Santa Cruz, CA (US); Nicholas Cesario, Santa Cruz, CA (US); Dylan Brown, Santa Cruz, CA (US); Maanas Maheshwari, Scotts Valley, CA (US)

(21) Appl. No.: 18/671,053

(22) Filed: May 22, 2024

Related U.S. Application Data
(60) Provisional application No. 63/468,216, filed on May 22, 2023.

(51) Int. Cl. C08J 3/12; C08J 9/00; C08J 9/228

(52) U.S. Cl. CPC C08J 3/12; C08J 9/0004; C08J 9/0095; C08J 9/228; C08J 2305/00

(57) ABSTRACT

A foam precursor is described. The foam precursor comprises a starch, a lubricant, and a linear polysaccharide different from the starch. The starch is at least 25% by weight amylose content. A density of the foam precursor is from 0.5 g/cm³ to 1.0 g/cm³. A composition of the foam precursor includes a starch weight percent representative of the starch included in the foam precursor and a polysaccharide weight percent representative of the linear polysaccharide included in the foam precursor. The starch weight percent is greater than the polysaccharide weight percent.

### CROSS-REFERENCE TO RELATED APPLICATION

This application claims the benefit of U.S. Provisional Application No. 63/468,216, filed May 22, 2023, which is hereby incorporated by reference in its entirety.

### TECHNICAL FIELD

This disclosure relates generally to foam precursor manufacturing for foam products, and in particular but not exclusively, relates to biodegradable foam precursors and products.

### BACKGROUND INFORMATION

Plastic pollution is one of the most pressing environmental issues in modern society. Plastic objects and particles (e.g., plastic bottles, bags, containers, packaging, microbeads, and the like) may accumulate in the environment and adversely affect humans, wildlife, and their habitat. While plastics have achieved ubiquitous use aided by their inexpensive cost and durability, the sheer volume of plastic produced throughout the world results in an unsustainable amount of plastic waste being generated. Additionally, due to the durability, most plastics are resistant to many natural processes of degradation and thus persist within the environment. Plastic waste may be hazardous to life on earth as humans and animals may inadvertently ingest plastic waste and be afflicted by problems related to ingestion, animals may become physically entangled within plastics, and toxic chemicals included in many plastics may leach into water supplies that are used by humans or animals.

Plastics are commonly used in packaging materials, which are inherently wasteful by typically being one time use (e.g., to protect a product traversing being shipped from a manufacturer or retailer to a consumer) while also unlikely to be recycled, meaning most waste from packaging materials ends up in an incinerator, a landfill, or otherwise accumulates in the environment. Plastic foams (e.g., expanded polystyrene) in particular are regularly used as packaging materials and may significantly contribute to plastic pollution. One avenue to address the ongoing crisis of plastic pollution to replace plastics with more environmentally friendly variants that are biodegradable.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described.

FIG. 1 illustrates a process of manufacturing a biodegradable foam by converting raw materials into a foam precursor followed by converting the foam precursor to the biodegradable foam, in accordance with an embodiment of the present disclosure.

FIG. 2 illustrates chemical compositions of various ingredients that may be utilized to form a biodegradable foam, in accordance with an embodiment of the present disclosure.

FIG. 3A illustrates an example schematic of an extruder capable of outputting an extrudate corresponding to a foam precursor or a foam that is biodegradable, in accordance with an embodiment of the present disclosure.

FIG. 3B illustrates a more detailed view of the extruder in the example schematic of FIG. 3A, in accordance with an embodiment of the present disclosure.

FIG. 4A illustrates an example method for fabricating a foam precursor, that is biodegradable, in accordance with an embodiment of the present disclosure.

FIG. 4B illustrates an example method for fabricating a biodegradable foam from a foam precursor, in accordance with an embodiment of the present disclosure.

FIG. 5A illustrates an example granulation temperature profile for forming a foam precursor with an extruder having a plurality of temperature-controlled zones, in accordance with an embodiment of the present disclosure.

FIG. 5B illustrates an example foaming temperature profile to foam a foam precursor with an extruder to form a foam that is biodegradable, in accordance with an embodiment of the present disclosure.

### DETAILED DESCRIPTION

Embodiments of foam precursors, foam, and corresponding methods of manufacture are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Described herein are embodiments of foam precursors and foams with high amylose starch content and methods thereof. In particular, it has been found that by utilizing a starch with a high amylose content in accordance with embodiments of the disclosure, foam precursors may be formed that have reduced or minimal foaming. The resultant foam precursors have higher density than typical foams to enable reduced transportation costs (e.g., from a manufacturer to a vendor, distributor, or otherwise) while maintaining biodegradability without the use of toxic chemicals. The foam precursor can be reprocessed with or without additional components to then form a foam having a lower density than the corresponding density of the foam precursor. This change in volume (e.g., from foam precursor to foam) enables more efficient transportation (e.g., in terms of cost and/or energy) of packing materials as the foam precursor and the foam itself may be manufactured at different sites. For example, the foam precursor may be manufactured at scale at a central manufacturing site and then shipped to different secondary sites close to relevant third parties (e.g., vendors, distributors, customers, and the like). The foam precursor may then be converted to a foam (e.g., a foam product) at the different secondary sites and transported locally to the relevant third parties.

Additionally, the two-step manufacturing processes (i.e., formation of foam precursors followed by foam formation by foaming the foam precursors) described in embodiments of the disclosure may further be able to utilize an increased amount of readily available biomaterials for manufacture, which may advantageously improve foam biodegradability. Specifically, some embodiments may utilize chitosan or other linear polysaccharides to form biodegradable foam precursors and foams. Chitosan for example, is typically viewed as a waste product of the seafood industry but may be repurposed in embodiments of the disclosure for foam manufacture. It was found that dosing solid chitosan enables increased loading relative to liquid dosing when forming the foam precursors, which may further enhance the environmental sustainability of the foam precursor and foams described in embodiments of the disclosure.

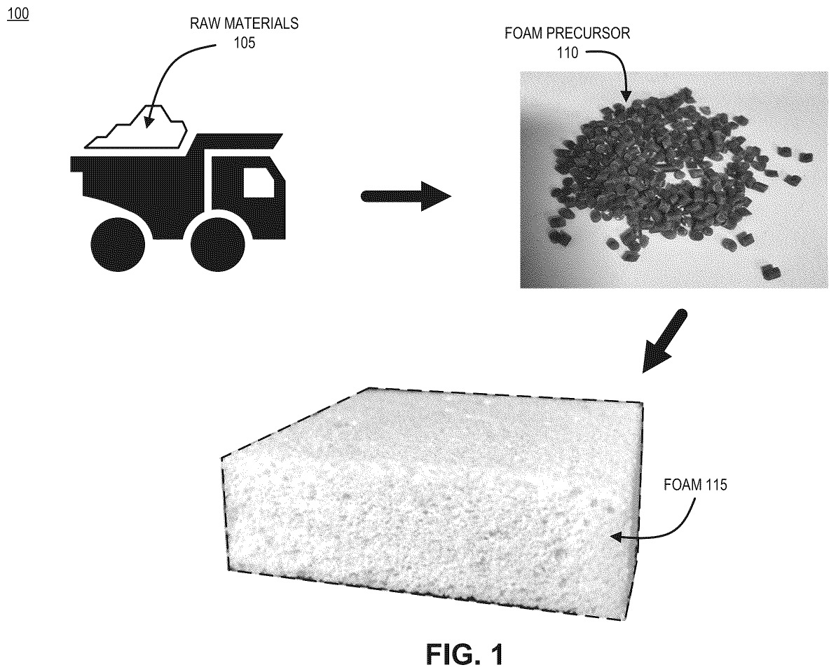

FIG. 1 illustrates a process 100 of manufacturing a biodegradable foam by converting raw materials 105 into a foam precursor 110 followed by converting the foam precursor 110 to the biodegradable foam 115, in accordance with an embodiment of the present disclosure. It is appreciated that that process 100 is a two-step manufacturing process, which can be achieved at different locations. For example, the raw materials 105 may be converted to the foam precursor 110 at a first location (e.g., a central manufacturing site). The foam precursor 110 may then be distributed to one or more secondary sites (e.g., local manufacturing sites physically closer to vendors, distributors, customers, and the like) to convert the foam precursor 110 into the foam 115. It is appreciated that the foam precursor 110 may have a first density (e.g., from 0.5 g/cm³ to 1.5 g/cm³) that is greater than a second density (e.g., from 0.01 g/cm³ to 0.5 g/cm³) of the foam 115. It is appreciated that example ranges of the first density and the second density are approximations and may have variance of up to 10%, in some embodiments. Additionally, it is appreciated that in other embodiments different ranges than those explicitly listed may be utilized depending on the target properties of the resultant foam. It is appreciated that in embodiments of the disclosure, the foam precursor 110 and the foam 115 are both solid materials at standard temperature (e.g., room temperature such as 25° C.) and pressure (e.g., 1 atm), meaning the bulk transportation cost and energy utilization (i.e., transportation carbon footprint) is largely based on the density of the materials being transported (i.e., the first density of the foam precursor 110 and the second density of the foam 115). Accordingly, the two-step manufacturing process illustrated by process 100 may advantageously reduce transportation expenses and the transportation carbon footprint since the higher density material (i.e., the foam precursor 110) is shipped to the one or more secondary sites and then subsequently shipped to relative third parties (e.g., relative to shipping the foam 115 directly to the relevant third parties).

Additionally, the foam precursor 110 and the foam 115 may be biodegradable to reduce the environmental impact such that even if the foam precursor 110 and/or the foam 115 end up within a waste stream, they will decompose at a rate faster than typical plastic products. A non-exhaustive list of components (e.g., the raw materials 105) that may be included in the foam precursor 110 and/or the foam 115 includes any one or more of or combinations of one or more starches (e.g., pea starch) with at least 25% by weight amylose content (e.g., 25% to 100% amylose content by weight), one or more lubricants (e.g., glycerol monostearate or other similar ester lubricants, hydrogenated castor wax, glycerol distearate, and glycerol tristearate, and/or ethylene glycol distearate), one or more linear polysaccharides different from the one or more starches (e.g., chitin, chitosan, chitosan oligosaccharide, cellulose), one or more nucleators (e.g., calcium carbonate, talc), one or more plasticizers (e.g., glycerol, sorbitol, urea), water, or acid (e.g., acetic acid).

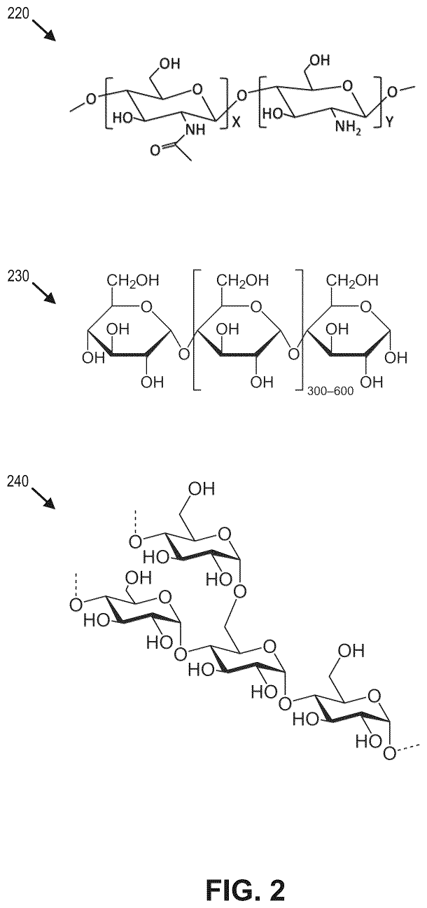

FIG. 2 illustrates chemical compositions of various ingredients that may be utilized to form a biodegradable foam, in accordance with an embodiment of the present disclosure. The chemical compositions include structure 220 corresponding to a linear polysaccharide such as chitin or chitosan and a starch including amylose 230 and optionally amylopectin 240. In particular, it was found that utilizing starches with a significant amount of amylose content (e.g., 25% by weight or higher up to 100%) in combination with a linear polysaccharide such as structure 220 enables the manufacture of a foam precursor (e.g., the foam precursor 110) that can be foamed at a secondary step. In particular, it was found that when amylose content is lower than 25% by weight of a given starch it became difficult to foam or was otherwise nonviable since the secondary material (e.g., amylopectin 240) has a branched structure, which impedes constituent components of the foam to “flow” during processing. More specifically, starches with lower than 25% amylose content are difficult to foam because it does not allow proper plasticization and gelation. This results in burning during extrusion. However, amylose molecules (as indicated by amylose 230) are linear and flow better than amylopectin 240. This combination of two linear components (e.g., structure 220 and amylose 230) allows for better expansion during foaming.

It is appreciated that structure 220 corresponds to chitin or chitosan based on the degree of deacetylation (i.e., the relative amounts of X blocks with acetyl group and Y blocks with amine group) in the chain. It is appreciated that in most embodiments of the disclosure, the foam precursor and foam (e.g., the foam precursor 110 and the foam 115 illustrated in FIG. 1 or otherwise described in embodiments of the disclosure) utilize chitosan due to its increased solubility in an acidic solution relative to chitin. Chitosan is defined as when a majority (i.e., greater than 50%) of the composition of structure 220 comprises the Y blocks (e.g., Y is greater than X) while chitin is defined as when a majority of the composition of structure 220 comprises X blocks (e.g., X is greater than Y). It is appreciated that chitosan is a derivative of chitin, which can be deacetylated by replacing the N-acetyl-glucosamine group with an N-glucosamine (Y block) resulting in a more hydrophilic and positively charged polymer, which can also be described as partially deacetylated chitin. Alternatively, acetylation of chitosan can yield a partially acetylated chitosan. When the ratio between acetyl and amine groups is higher than 1:1 (e.g., X>Y such that there is greater than a 50%/50% split of the two monomer units), the partially deacetylated chitin polymer may be referred to as chitin, when the ratio is lower, the partially acetylated chitosan polymer may be referred to as chitosan. Put another way, chitosan has 50% or more N-glucosamine groups (e.g., Y blocks), whereas chitin has more than 50% N-acetyl-glucosamine groups (e.g., X blocks). Chitosan oligosaccharide has the same molecular structure as chitosan as described, just with a lower molecular weight (fewer monomer units) than the polymers of chitin or chitosan. In some embodiments, the degree of deacetylation for chitosan included in the foam precursor or foam of embodiments in the disclosure is greater than 60% (e.g., 60%-100% Y blocks of structure 220), greater than 70% (e.g., 70%-100% Y blocks of structure 220), or greater than 80% (e.g., 80%-100% Y blocks of structure 220).

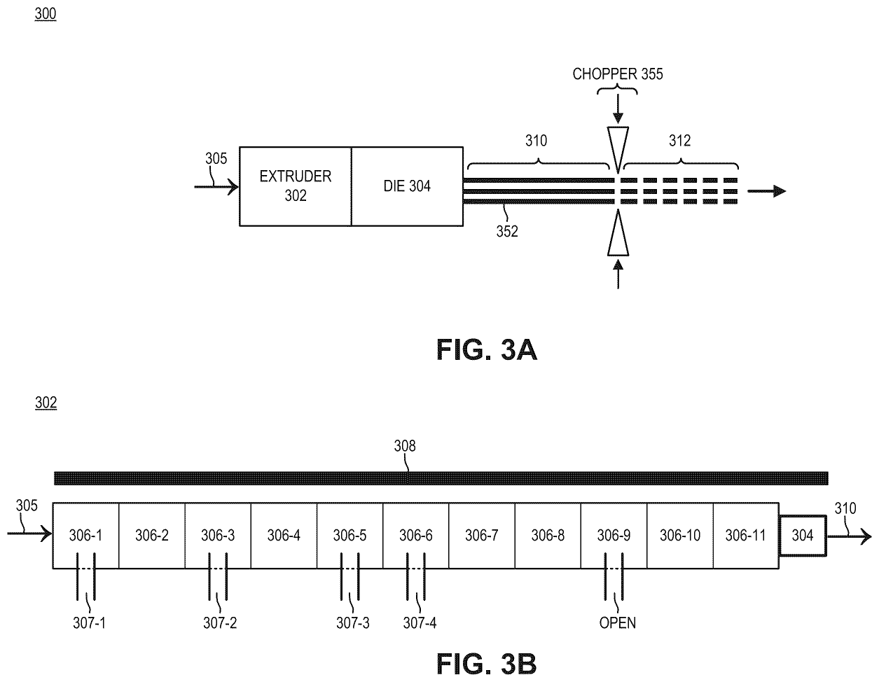

FIG. 3A illustrates an example schematic 300 of an extruder 302 capable of outputting an extrudate 310 corresponding to a foam precursor or a foam that is biodegradable, in accordance with an embodiment of the present disclosure. More specifically, raw materials 305 (e.g., which may correspond to the raw materials 105 illustrated in FIG. 1) are input into the extruder 302 at predetermined dosing rates and locations within the extruder 302 which in turn outputs the extrudate 310 (e.g., which may correspond to the foam precursor 110 illustrated in FIG. 1). In some embodiments, the extrudate 310 is cut or otherwise chopped to form a plurality of granules or pellets 312. As discussed, the extrudate 310, or more specifically the plurality of granules 312, have limited foaming to enable more efficient transportation relative to the final foam product. The plurality of granules 312 may then be reprocessed and input into the extruder 302 to form a foam (e.g., the foam 115 illustrated in FIG. 1) as part of the two-step manufacturing process.

Accordingly, it is appreciated that extrudate 310 and/or the plurality of granules 312 may correspond to the foam precursor 110 illustrated in FIG. 1. In the illustrated embodiment of FIG. 3A, the plurality of granules 312 may be formed via the extruder 302, which optionally may include an extruder die 304. Extrusion is a process used to create objects by pushing material through an opening or a die of a desired cross-section shape and size. Extrusion creates excellent surface finish and gives considerable freedom of form in the design process. In some embodiments, extrusion may be continuous (e.g., theoretically producing indefinitely long material) or semi-continuous (e.g., producing many pieces). In the illustrated embodiment, the extruder 302 produces the extrudate 310, which may be a continuous or semi-continuous object.

As illustrated in FIG. 3A, raw materials 305 (e.g., solid and/or liquid input ingredients) are input into the extruder 302 in one or more inputs proximate to a first end of the extruder 302 that is opposite of a second end (e.g., an output or terminal end proximate to or otherwise formed by the die 304). The extruder 302 mixes and heats the raw materials 305 to continuously produce the extrudate 310. In some embodiments, the extruder die 304 is referred to as a “stranding die” that has many holes through which the extrudate blows to form one or more strands 352 of the extrudate 310. These strands may then be cooled and cut into smaller pieces (e.g., via the chopper 355) to produce the plurality of granules 312. In some embodiments, the plurality of granules 312 are allowed to cool and dry until they are below a predetermined moisture threshold (e.g., less than 15% moisture content, less than 14% moisture content, less than 13% moisture content, or other predetermined moisture thresholds). In some embodiments, the plurality of granules should be within a predetermined moisture range (e.g., from 10% to 16% moisture content by weight) to facilitate proper foaming of the plurality of granules 312 to form a foam. It is appreciated that the plurality of granules 312 do not necessarily need to be foamed by the same extruder 302 that was used to form the plurality of granules 312. For example, in some embodiments, the plurality of granules 312 may be formed by a twin-screw extruder while the foam may be formed by foaming the plurality of granules 312 using a single-screw extruder.

FIG. 3B illustrates a more detailed view of the extruder 302 in the example schematic 300 of FIG. 3A, in accordance with embodiments of the present disclosure. The extruder 302 includes a plurality of temperature-controlled zones 306 (e.g., a first zone 306-1, a second zone 306-2, a third module 306-3, a fourth zone 306-4, a fifth zone 306-5, a sixth zone 306-6, and so on until reaching an eleventh zone 306-11), which can each be configured to have a specific temperature during processing. Further, it is appreciated that the die 304 may also be similarly configured to be heated (e.g., by heater 308) such that the region associated with the die 304 may also be set to a predetermined temperature or temperature range. It is appreciated that the plurality of temperature-controlled zones 306 are not intended to be limiting as there may be more or less zones than the illustrated eleven zones (e.g., 306-1 through 306-11). Additionally, it is noted that while the plurality of temperature-controlled zones 306 are arranged in sequential order, there may be additional zones between zones that are illustrated as being adjacent, in some embodiments. For example, in one embodiment there may be one or more zones included in the plurality of temperature-controlled zones 306 between the second zone 310-2 and the third zone 310-3. In the illustrated embodiment, raw materials 305 are input into the extruder 302 for forming the extrudate 310, which flow along the extruder 302 in the direction the arrow associated the raw materials 305 until the extrudate 310 is output. (e.g., one or more components of the raw materials 305 may be input into the extruder 305 at the first zone 306-1 through input port 307-1). More specifically, the input ingredients for forming the extrudate 310 flows or otherwise propagate towards the die 304 (e.g., from a first end proximate to the first zone 306-1 towards a second end opposite the first end that is proximate to the eleventh zone 306-11). The input ingredients are subsequently mixed together at predetermined propagation profiles (e.g., rate, pressure, temperature, and the like) to form the extrudate 310.

However, it is appreciated that not all components included in the raw materials 305 are necessarily input at the same location. Rather, different ingredients may be input into the extruder 302 at different dosing rates and locations. Accordingly, the extruder 302 includes a plurality of input ports 307 (e.g., 307-1, 307-2, 307-3, and 307-4) as illustrated, but it is appreciated that additional or few input ports may be utilized. The plurality of input ports 307 may facilitate dosing liquid and solid ingredients or mixtures into the extruder 302 at different rates and locations. Additionally, one or more input ports included in the plurality of input ports 307 may be configured as a vent port (e.g., the input port associated with zone 306-9 labeled as “open”) to facilitate pressure control (e.g., in the case of forming the foam precursor 110 illustrated FIG. 1, the open vent port of zone 306-9 is open to ambient pressure of the environment, such as 1 atm, to mitigate foaming of the foam precursor).

In some embodiments, the extruder 302 may be a twin screw extruder and the barrel (e.g., the plurality of temperature-controlled zones 306) of the extruder 302 may be heated between the first end and the second end (e.g., via heater 308). As illustrated, the mixture of components proceeds through the plurality of temperature-controlled zones 306 to form the extrudate 310, which is passed through the die 304 proximate to the second end of the extruder 302 to impart a cross sectional shape to the extrudate 310. However, it is appreciated that the die 304 is an optional component and may be omitted in some embodiments such that the terminal end of the extruder 302 has no die or restriction through which the extrudate 310 passes.

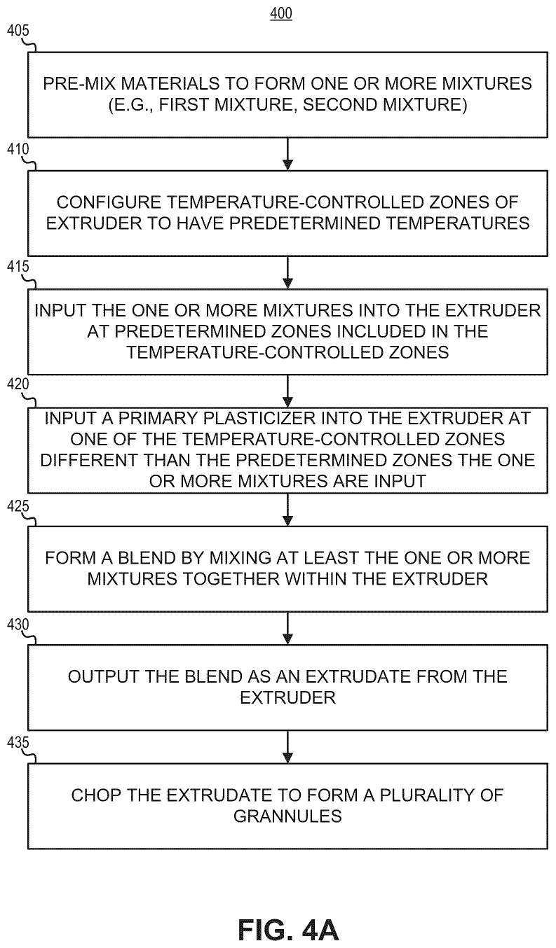

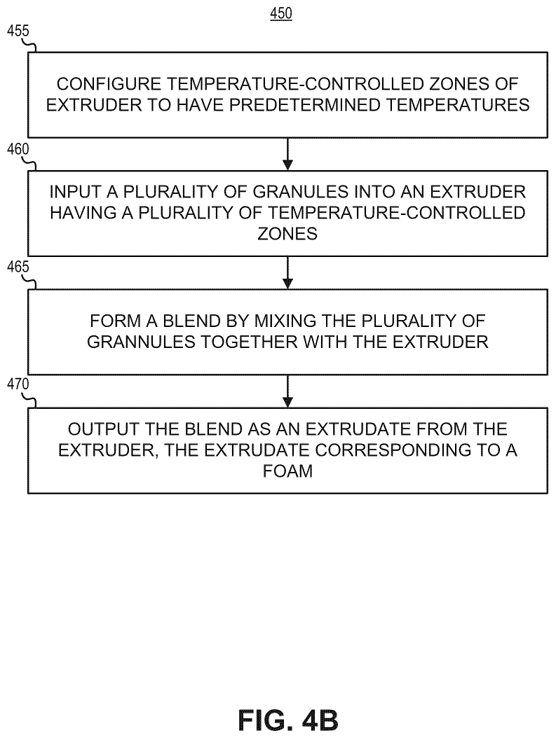

FIG. 4A illustrates an example method 400 for fabricating a foam precursor (e.g., the foam precursor 110 illustrated in FIG. 1), that is biodegradable, in accordance with an embodiment of the present disclosure. The method 400, which includes blocks 405-435, may be one possible implementation for fabricating the foam precursor 110 illustrated in FIG. 1. The order in which some or all of the process blocks appear in method 400 should not be deemed limiting. Rather, one of ordinary skill in the art having the benefit of the present disclosure will understand that some of the process blocks may be executed in a variety of orders not illustrated, or even in parallel.

Block 405 shows pre-mixing materials to form one or more mixtures before the one or more mixtures are input into an extruder (e.g., the extruder 302 illustrated in FIGS. 3A-3B). In some embodiments, solid materials are pre-mixed before input into the extruder. In one embodiment, the one or more mixtures includes a first mixture of solid materials. The first mixture includes a starch with at least 25% by weight amylose content (e.g., pea starch) and a lubricant (e.g., e.g., glycerol monostearate or other similar ester lubricants, hydrogenated castor wax, glycerol distearate, and glycerol tristearate, ethylene glycol distearate, or combinations thereof). In some embodiments, the first mixture is pre-mixed in a high intensity mixer until the first mixture reaches a pre-mix temperature greater than 70% of a melting point of the lubricant up to 100% of the melting point. In one embodiment, the lubricant includes glycerol monostearate and the pre-mix temperature is between approximately of 50° C. and 70° C. (e.g., within 10%), which melts the lubricant to facilitate interspersing the lubricant with the other solid materials included in the first mixture (e.g., the starch) while also reducing fine particles within the first mixture. In the same or other embodiments, the pre-mix temperature is about 50° C. (e.g., within 10%).

In the same or other embodiments, the first mixture further includes at least one or more nucleators (e.g., a primary nucleator and one or more secondary nucleators different from the primary nucleator). In some embodiments, the one or more nucleators include calcium carbonate and talc (e.g., calcium carbonate may be a primary nucleator while talc may be included as one or more secondary nucleators). In other embodiments, the primary nucleator includes at least one of calcium carbonate or talc. In the same or other embodiments, the one or more secondary nucleators may be omitted. In the same or other embodiments, the first mixture includes one or more secondary plasticizers that are different than a primary plasticizer. In some embodiments, the primary plasticizer includes glycerol and the one or more secondary plasticizers include at least one of sorbitol or urea. It is appreciated that the one or more secondary plasticizers may be solid materials that are included in the first mixture while the primary plasticizer may not be a solid material or otherwise not be included or otherwise blended with the first mixture until input into the extruder.

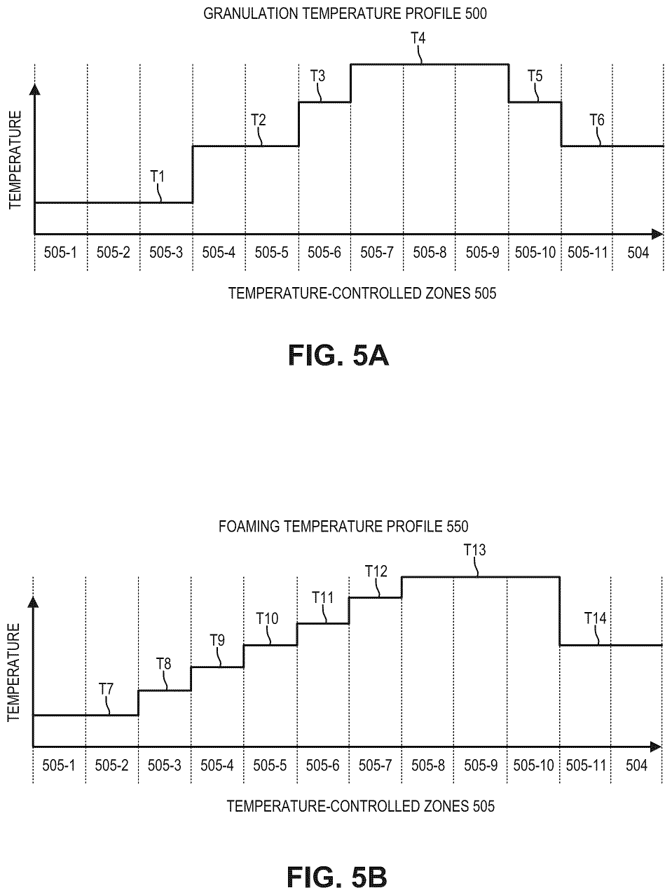

Block 410 illustrates configuring the plurality of temperature-controlled zones of the extruder to have predetermined temperatures. Depending on the functionality (e.g., whether a foam precursor or a foam is being formed), the profile of the temperature-controlled zones may change. Accordingly, individual setpoint temperatures of the plurality of temperature-controlled zones may be configured to follow a predetermined temperature profile (see, e.g., FIG. 5A and FIG. 5B for example temperature profiles for granulation to form the foam precursor and foaming to form the foam). In some embodiments, at least an initial temperature of a proximal zone and an intermediary temperature of an intermediary zone included in the plurality of temperature-controlled zones of the extruder are configured such that the intermediary temperature is greater than the initial temperature. For example, referring to FIG. 3B, the intermediary zone is disposed between the proximal zone and the die 304 of the extruder 302. Referring to FIG. 5A, the initial temperature may correspond to T1 and the intermediary temperature may correspond to any other temperature (e.g., T3, T4, T5 and so on).

In some embodiments, configuring the plurality of temperature-controlled zones may further include configuring a distal temperature of a distal zone disposed between the die of the extruder and the intermediary zone. The distal temperature of the distal zone may be configured to be greater than the initial temperature of the proximal zone but less than the intermediary temperature of the intermediary zone. For example, referring to FIG. 5A, the intermediary temperature corresponds to T3, T4, or T5 while the distal temperature corresponds to T6. In the same or other embodiments, the plurality of temperature-controlled zones of the extruder may be configured to follow a temperature profile that gradually increases in temperature until reaching a peak temperature that is held over a one or more of the plurality of temperature-controlled zones and then is subsequently reduced. In the same or other embodiments, the plurality of temperature-controlled zones includes a vent port zone (e.g., zone 306-9 included in extruder 302 illustrated in FIG. 3B) disposed between the die and the intermediary zone. The vent port zone may be open to ambient pressure to mitigate foaming when forming the foam precursor (e.g., such that when the first mixture, the second mixture, and other constituent components are input into the extruder 302 foaming is mitigating when forming the foam precursor). More specifically, the vent port allows removal of excess water and reduction of pressure. The release in pressure ensures that the blend does not foam and increases density of the foam precursor. In some embodiments, the vent port zone may have a configured temperature substantially equal (e.g., within 10%) to the intermediary temperature. In the same or other embodiments, the configured temperature of the vent port and the intermediary temperature correspond to a peak temperature of the temperature profile using for forming the foam precursor (e.g., the intermediary temperature and the configured temperature of the vent port may correspond to T4 of FIG. 5A).

Block 415 shows inputting the one or more mixtures into the extruder at predetermined zones included in the plurality of temperature-controlled zones. As discussed previously, the one or more mixtures includes a first mixture of solid materials. The one or more mixtures may further include a second mixture including a linear polysaccharide different from the starch included in the first mixture. The linear polysaccharide may include, for example, chitin, chitosan, chitosan oligosaccharide, cellulose, or combinations thereof. It is appreciated that the first mixture and the second mixture may be input into the extruder at different zones included in the plurality of temperature-controlled zones. For example, the second mixture may be input into the extruder before the first mixture (e.g., the first mixture may be input into a zone such as 306-5 by input port 307-3 of FIG. 3B while the second mixture may be input into a zone such as 306-1 via input port 307-1). In some embodiments, the second mixture corresponds to a liquid solution (e.g., liquid dosing of the linear polysaccharide such as chitosan dissolved in an acidic aqueous solution). For example, the second mixture may further include water and an acid (e.g., acetic acid) to dissolve the chitosan. In other embodiments, the second mixture is input into the extruder as a solid. In some embodiments, the first mixture and the second mixture are input into the extruder at a same zone included in the plurality of temperature-controlled zones (e.g., when the first mixture and the second mixture correspond to a solid state of matter).

Block 420 illustrates inputting a primary plasticizer into the extruder in a different zone included in the plurality of temperature-controlled zones than corresponding zones the first mixture and the second mixture are input. It is appreciated that the primary plasticizer may be input into the extruder after the other ingredients (e.g., the first mixture and the second mixture, acid aqueous solution, and the like) such that plasticization and gelation generally occur after components included in the other ingredients are at least partially blended. In some embodiments, the primary plasticizer includes glycerol. In some embodiments, an aqueous solution including an acid (e.g., acetic acid) is input into the extruder. In some embodiments the aqueous solution has a pH below 6.5. In another embodiment, the aqueous solution has a pH from 4 to 5.5 to facilitate dissolution of the linear polysaccharide (e.g., chitosan) into solution. Accordingly, in some embodiments, the aqueous solution is input into the extruder after the second mixture (e.g., the second mixture including the linear polysaccharide may be input into zone 306-1, the aqueous solution input into zone 306-3, and the primary plasticizer input into zone 306-6 illustrated in FIG. 3B). More generally, the plurality of temperature-controlled zones may include a first zone, a second zone, a third zone, and a fourth zone. The second zone is disposed between the first and the third zone and the fourth zone is disposed between the third zone and the die of the extruder. In the same or other embodiments, the third zone is disposed between the second zone and the fourth zone. In some embodiments, the second mixture is input into the first zone, the aqueous solution is input into the second zone, the first mixture is input into the third zone, and the primary plasticizer is input into the fourth zone. It is appreciated that there may be one or more zones included in the plurality of temperature-controlled zones disposed between the first, second, third, or fourth zones. For example, there may be one or more zones disposed between the first zone and the second zone, one or more zones disposed between the second zone and the third zone, and so on.

In some embodiments, dosing rates of materials to form the blend (e.g., the combination of at least the first mixture and the second mixture) input by weight into the extruder includes 5% to 20% of one or more plasticizers (e.g., a primary plasticizer including glycerol), 1% to 20% linear polysaccharide (e.g., chitosan in water or solid chitosan), and 60% to 80% of other sold materials (e.g., the combination of starch with amylose content of 25% or more such as pea starch, lubricant such as glycerol monostearate, one or more nucleators such as calcium carbonate and talc, and one or more secondary plasticizers such as sorbitol or urea). In the same or other embodiments, the blend further includes an aqueous solution with a predetermined pH (e.g., an acid such as acetic acid diluted with water) of below 6.5 (e.g., between 4 to 5.5) to dissolve the chitosan into solution. In some embodiments, the inherent water in the combined materials is between 8% to 17% by weight (e.g., water weight percent). In the same or other embodiments, the water weight percent is from 13% to 17%. In another embodiment, the water weight percent is from 13% to 14%. In embodiments where there is a greater amount of the linear polysaccharide (e.g., polysaccharide weight percent is up to 50%), a greater amount of water may be incorporated into dosing when forming the blend, the foam precursor, and/or the foam. In such an embodiment, the inherent water in the combined materials is from 5% to 30% by weight. In the same or other embodiment, the water content of materials fed into the extruder for granulation is between 20% to 20% by weight, or more preferably between 22% and 25% by weight. In some embodiments, the increased loading of the linear polysaccharide (e.g., chitosan) results in a foam precursor composition that omits the one or more nucleators (e.g., calcium carbonate and talc) and one or more secondary plasticizers (e.g., sorbitol and urea).

It is appreciated that when forming the blend, the calcium carbon included in the one or more nucleators may neutralize the acetic acid while facilitating nucleation of the foam precursor and foam. In one embodiment, there is at least an equal amount of moles to acetic acid to neutralize the acetic acid when forming the blend. In some embodiments, a weight percent of the one or more nucleators (e.g., calcium carbonate weight percent) is from 0.5% to 2% to facilitate improvement in the foam precursor cell structure to aid in smaller cell size. In some embodiments it was found that exceeding 2% calcium carbon weight percent may reduce density of the foam precursor (e.g., initiate foaming of the foam precursor when not desired). Talc may be similarly limited to between 0.5% to 2% weight percent in some embodiments as it was similarly found that greater than 2% weight percent may reduce density of the of the foam precursor (e.g., initiate foaming of the foam precursor when not desired) and does not aid in the smaller cell size.

Block 425 shows forming a blend by mixing at least the first mixture and the second mixture together as the first mixture and the second mixture propagate through the plurality of temperature-controlled zones. It is appreciated that the extruder may include one or more “screws” that rotate causing the input ingredients to be mixed or otherwise blended as they propagate through the extruder towards the die to be output as an extrudate. Accordingly, the order in which ingredients are input into the extruder may materially affect properties of the product output (e.g., the foam precursor). For example, the linear polysaccharide included in the second mixture may be input as a solid before inputting other solid ingredients. Rather, the aqueous solution is input after the linear polysaccharide to facilitate dissolution of the linear polysaccharide before being mixed or otherwise blended with other ingredients (e.g., other solid input materials such as those included in the first mixture, the primary plasticizer, and the like). It is appreciated that in doing so facilitates a greater loading of the linear polysaccharide (e.g., up to and including 50% by weight of the linear polysaccharide may be loaded into the foam precursor). It is appreciated that liquid loading of the linear polysaccharide (e.g., first dissolving the chitosan in the aqueous solution before input into the extruder) may be unable to facilitate such high loading (e.g., liquid dosing of the linear polysaccharide may be limited to from 1% to 20% by weight in the foam precursor). In some embodiments, liquid dosing of the linear polysaccharide may be limited to 2% by weight due to the difficult to dissolving the linear polysaccharide in a liquid solution when the linear polysaccharide includes chitosan. Additionally, it is noted that the composition of the blend is based on the input ingredients into the extruder (e.g., the blend may include the first mixture, the second mixture, the aqueous solution, the primary plasticizer, and any other ingredient input into the extruder).

Block 430 illustrates outputting the blend as an extrudate from the extruder corresponding to a foam precursor (e.g., the foam precursor 110 illustrated in FIG. 1). In some embodiments, a composition of the foam precursor includes a starch weight percent representative of the starch included in the foam precursor (e.g., from the first mixture) and a polysaccharide weight percent representative of the linear polysaccharide (e.g., from the second mixture) included in the foam precursor. In some embodiments, the starch weight percent is greater than the polysaccharide weight percent. Additionally, it is appreciated that the foam precursor is a solid at standard conditions (e.g., 25° C. and 1 atm) with a density from 0.5 g/cm³ to 1.5 g/cm³. In the same or other embodiments, the composition of the foam precursor includes a lubricant weight percent representative of the lubricant (e.g., from the first mixture) included in the foam precursor. In the same or other embodiments, the lubricant weight percent is from about 0.5% to about 4%. It is appreciated that by having a lubricant weight percentage of at least 0.5% allows the blend to flow through the extruder without burner, but that exceeding a weight percent greater than 4% for the lubricant weight percent may inhibit the extruder from properly mixing, shearing, and heating the blend. In some embodiments, the lubricant weight percent is less than the polysaccharide weight percent. In the same or other embodiments, the polysaccharide weight percent is greater than a primary plasticizer weight percent representative of the primary plasticizer included in the foam precursor. In some embodiments, the linear polysaccharide is input into the extruder as a liquid (e.g., dissolved in the aqueous solution) with the polysaccharide weight percent being from about 0.5% to about 2%. In other embodiments, the linear polysaccharide is input into the extruder as a solution with the polysaccharide weight percent being from about 5% to about 50% (e.g., within 10% of either end of the range). In some embodiments, the primary plasticizer weight percent is from about 5% to about 20% (e.g., within 10% of either end of the range). In one embodiment, the primary plasticizer weight percent is about 15% (e.g., within 10%). Accordingly, in some embodiments, the polysaccharide weight percent is greater than the primary plasticizer weight percent.

Block 435 shows chopping the extrudate to form a plurality of granules, each granule included in the plurality of granules having a corresponding composition substantially equivalent to the foam precursor. In other words, the extrudate (i.e., the foam precursor) is cut or otherwise shaped to facilitate easier packaging (e.g., for transport) and/or handling (e.g., for input of the foam precursor into an extruder for foaming). Each granule included in the plurality of granules may correspond to a solid material having a volume of less than 1 cm³. However, it is appreciated that other dimensions may be utilized, but it is noted that chopping the extrudate may facilitate foaming during a subsequent process (e.g., to convert the foam precursor to the foam).

In one embodiment, the foam precursor in extrudate form or as a plurality of granules (or foam) may have a composition consisting of or including any permutation of the following material ranges by weight percent: 50% to 80% pea starch, 1% to 10% chitosan, 1% to 5% glycerol monostearate, 1% to 3% calcium carbonate, 1% to 3% talc, 1% to 5% sorbitol, 1% to 5% urea, 1% to 20% glycerol, 0.1% to 3% acetic acid, and 5% to 20% water.

In another embodiment, the foam precursor in extrudate form or as a plurality of granules (or foam) may have a composition consisting of or including any permutation of the following material ranges by weight percent: 50% to 95% pea starch, 5 to 50% chitosan, 1% to 5% glycerol monostearate or other similar ester lubricants, hydrogenated castor wax, glycerol distearate, glycerol tristearate, ethylene glycol distearate, or combinations thereof, 5% to 15% glycerol, 0.1% to 3% acetic acid, and 5% to 30% water.

As discussed previously, a non-exhaustive list of components that may be included in the foam precursor and/or the foam includes any one or more of or combinations of one or more starches (e.g., pea starch) with at least 25% by weight amylose content, one or more lubricants (e.g., glycerol monostearate or other similar ester lubricants, hydrogenated castor wax, glycerol distearate, and glycerol tristearate, and/or ethylene glycol distearate), one or more linear polysaccharides different from the one or more starches (e.g., chitin, chitosan, chitosan oligosaccharide, cellulose), one or more nucleators (e.g., calcium carbonate, talc), one or more plasticizers (e.g., glycerol, sorbitol, urea), water, or acid (e.g., acetic acid). Accordingly, based on the possible configuration discussed above the foam precursor or the foam includes a starch that has at least 25% by weight amylose content, a lubricant, and a linear polysaccharide different from the starch. A composition of the foam precursor includes a starch weight percent representative of the starch included in the foam precursor and a polysaccharide weight percent representative of the linear polysaccharide included in the foam precursor. In most embodiments, the starch weight percent is greater than the polysaccharide weight percent. In the same or other embodiments, the foam precursor includes a lubricant weight percent representative of the lubricant included in the foam precursor that is from about 0.5% to about 4%. In some embodiments, the composition of the foam precursor includes a lubricant weight percent representative of the lubricant included in the foam precursor. In one embodiment, the lubricant weight percent is less than the polysaccharide weight percent.

In the same or another embodiment, the foam precursor further includes at least one of a primary nucleator, one or more secondary nucleators different from the primary nucleator, a primary plasticizer, or one or more secondary plasticizers different from the primary plasticizer. In one embodiment, the foam precursor includes a primary plasticizer weight percent representative of the primary plasticizer included in the foam precursor and a secondary plasticizer weight percent representative of the one or more secondary plasticizers included in the foam precursor. In the same or another embodiment, the primary plasticizer weight percent is greater than the secondary plasticizer weight percent, each of which are greater than zero. In one embodiment, the polysaccharide weight percent is greater than the primary plasticizer weight percent. In one embodiment the primary plasticizer includes glycerol and the one or more secondary plasticizers includes at least one of sorbitol or urea. In one embodiment, the primary plasticizer weight percent is from 5% to 20%. In the same or another embodiment, the primary plasticizer weight percent is about 15%. In some embodiments, the foam precursor includes a water weight percent representative of water included in the foam precursor. In the same embodiment, the polysaccharide weight percent is greater than the water weight percent.

In some embodiments, the primary plasticizer weight percent of the primary plasticizer included in the one or more plasticizers is approximately 15% when the primary plasticizer consists of glycerol. It was found that having at least 15% by weight of the primary plasticizer included in the foam precursor or foam reduces compressibility while having greater amount (e.g., 17% or more) reduces the compression strength of the foam below target requirements.

FIG. 4B illustrates an example method for fabricating a biodegradable foam from a foam precursor, in accordance with an embodiment of the present disclosure. The method 450, which includes process blocks 445-470, may be one possible implementation for fabricating the foam 115 illustrated in FIG. 1. The order in which some or all of the process blocks appear in method 450 should not be deemed limiting. Rather, one of ordinary skill in the art having the benefit of the present disclosure will understand that some of the process blocks may be executed in a variety of orders not illustrated, or even in parallel. It is further appreciated that the method 450 may be used in combination with method 400 illustrated in FIG. 4A to convert the plurality of granules (e.g., the foam precursor) to the foam. It is appreciated that the same extruder may be utilized by both methods 400 and 450. Alternatively, different extruders at different locations may be utilized (e.g., such that the foam precursor can be shipped as the plurality of granules to relevant third parties in a most cost and energy efficient manner).

Block 455 shows configuring a plurality of temperature-controlled zones of an extruder to have predetermined temperatures (see, e.g., FIG. 5B). It is appreciated that the plurality of temperature-controlled zones may be contributed to initially be approximate to room temperature (e.g., T7 of FIG. 5B) and then steadily ramped or stepped to a peak or melt temperature (e.g., T13 of FIG. 5B) before dropping down to a lower temperature (e.g., T14 of FIG. 5B) to be output. In some embodiments, the plurality of temperature-controlled zones may be configured to reach at least 200 psi (e.g., vent port is not open) during and specific mechanical energy is at least 0.125 to 0.175 kWh/kg during processing to facilitate foaming of the plurality of granules. Accordingly, it is appreciated when forming the foam precursor the pressure within the extruder is less than the pressure within the extruder when forming the foam.

Block 460 illustrates inputting the plurality of granules (e.g., the foam precursor) into an extruder having a plurality of temperature-controlled zones to foam the plurality of granules and output a second extrudate from the extruder corresponding to a foam. It is appreciated that since the foam precursor is preferably not foamed, the foam has a second density less than the density of the foam precursor. The plurality of granules may be formed, for example, by the method 400 illustrated in FIG. 4A or otherwise correspond to the foam precursor 110 illustrated in FIG. 1. It is appreciated that each granule included in the plurality of granules may have a composition including a starch having at least 25% by weight amylose content, a lubricant, and a linear polysaccharide different from the starch. In some embodiments, the composition includes a starch weight percent representative of the starch included in the plurality of the granules and a polysaccharide weight percent representative of the linear polysaccharide included in the plurality of the granules. In the same embodiment, the starch weight percent is greater than the polysaccharide weight percent.

Block 465 shows forming a blend by mixing the plurality of granules together as the plurality of granules propagate through the plurality of temperature-controlled zones. It is appreciated that in some embodiments, no other materials are input into the extruder but for the plurality of granules. In other words, the combination of heat, pressure, and specific mechanical energy provided by the extruder may be utilized to foam the plurality of granules to produce the second extrudate that corresponds to a foam. As discussed previously, the extruder may correspond to the extruder 302 illustrated in FIGS. 3A-3B in accordance with embodiments of the disclosure.

Block 470 illustrates outputting the blend as an extrudate from the extruder, the extrudate corresponding to a foam. In most embodiments, the plurality of granules has a first density and the foam has a second density less than the first density. In other words, the plurality of granules are foams to produce a less dense foam.

It is noted that while method 450 utilizes an extruder, in other embodiments the plurality of granules may be reprocessed with different means such as injection molding. In other words, it is appreciated that converting the foam precursor to the foam is not limited to just extrusion processes. Rather, the foam may be formed so long as sufficient pressure, heat, and mechanical energy is applied to the plurality of granules.

FIG. 5A illustrates an example granulation temperature profile 500 for forming a foam precursor with an extruder having a plurality of temperature-controlled zones, in accordance with an embodiment of the present disclosure. Specifically, the example granulation temperature profile 500 may be implemented with extruder 302 illustrated in FIGS. 3A-3B when performing the method 400 illustrated in FIG. 4A, in accordance with an embodiment of the disclosure. The example granulation temperature profile 500 illustrates temperature (e.g., ° C.) with respect to temperature-controlled zones 505 (e.g., zones 505-1 through 505-11 and zone 504 corresponding to the die of the extruder). In some embodiments, the temperature-controlled zones 505 may correspond to the plurality of temperature-controlled zones 306 illustrated in FIG. 3B (e.g., 506-1 corresponds to 306-1, 506-2 corresponds to 306-2, and so on), which may be used to infer relative temperature with respect to zones materials are input, vent port open, and the like. For example, materials may be input into the plurality of temperature-controlled zones 505 at zones 506-1, 506-3, 506-5, 506-6. However, it is appreciated that in other embodiments materials may be input into different zones. It is appreciated that in some embodiments, the specific temperatures represented by T1 through T6 may be within certain ranges. For example, in one embodiment, T1 corresponds to a null set point or room temperature (e.g., ambient temperature such as 25° C.), T2 corresponds to 90° C. to 120° C., T3 corresponds to 110° C. to 130° C., T4 corresponds to 120° C. to 150° C., T5 corresponds to 110° C. to 130° C., and T6 corresponds to 90° C. to 120° C.

FIG. 5B illustrates an example foaming temperature profile 550 to foam a foam precursor with an extruder to form a foam that is biodegradable, in accordance with an embodiment of the present disclosure. Specifically, the example foaming temperature profile 550 may be implemented with extruder 302 illustrated in FIGS. 3A-3B when performing the method 450 illustrated in FIG. 4B, in accordance with an embodiment of the disclosure. The example foaming temperature profile 550 illustrates temperature (e.g., ° C.) with respect to temperature-controlled zones 505 (e.g., zones 505-1 through 505-11 and zone 504 corresponding to the die of the extruder). In some embodiments, the temperature-controlled zones 505 may correspond to the plurality of temperature-controlled zones 306 illustrated in FIG. 3B (e.g., 506-1 corresponds to 306-1, 506-2 corresponds to 306-2, and so on), which may be used to infer relative temperature with respect to zones materials are input, vent port open, and the like. For example, materials may be input into the plurality of temperature-controlled zones 505 at zones 506-1, 506-3, 506-5, 506-6. For example, when foaming the plurality of granules, they may be input into zone 506-1. However, it is appreciated that in other embodiments materials may be input into different zones. It is appreciated that in some embodiments, the specific temperatures represented by T7 through T14 may be within certain ranges to foam the foam precursor (i.e., the plurality of granules). For example, in one embodiment, T7 corresponds to 25° C. to 50° C., T8 corresponds to 50° C. to 85° C., T9 corresponds to 100° C. to 115° C., T10 corresponds to 115° C. to 130° C., T11 corresponds to 125° C. to 140° C., T12 corresponds to 130° C. to 145° C., T13 corresponds to 135° C. to 150° C. and T14 corresponds to 115° C. to 130° C. As can be seen, the granulation temperature profile 500 and the foaming temperature profile 550 are quite different due to their different functions. For example, the granulation temperature profile 500 intends to minimize foaming while the foaming temperature profile 550 intends to maximize foaming.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A foam precursor, comprising:
a starch, wherein the starch is at least 25% by weight amylose content;
a lubricant; and
a linear polysaccharide different from the starch, wherein a density of the foam precursor is from 0.5 g/cm³ to 1.5 g/cm³, wherein a composition of the foam precursor includes a starch weight percent representative of the starch included in the foam precursor and a polysaccharide weight percent representative of the linear polysaccharide included in the foam precursor, and wherein the starch weight percent is greater than the polysaccharide weight percent.

2. The foam precursor of claim 1, wherein the linear polysaccharide includes chitosan, the starch includes pea starch, and the lubricant includes glycerol monostearate.

3. The foam precursor of claim 1, wherein the composition of the foam precursor includes a lubricant weight percent representative of the lubricant included in the foam precursor, wherein the lubricant weight percent is from about 0.5% to about 4%.

4. The foam precursor of claim 1, wherein the composition of the foam precursor includes a lubricant weight percent representative of the lubricant included in the foam precursor, wherein the lubricant weight percent is less than the polysaccharide weight percent.

5. The foam precursor of claim 1, wherein the foam precursor further includes at least one of a primary nucleator, one or more secondary nucleators different from the primary nucleator, a primary plasticizer, or one or more secondary plasticizers different from the primary plasticizer, wherein the primary nucleator includes at least one of calcium carbonate or talc, wherein the primary plasticizer includes glycerol and the one or more secondary plasticizers includes at least one of sorbitol or urea.

6. The foam precursor of any one of claims 1, wherein the foam precursor includes a primary plasticizer and one or more secondary plasticizers, wherein the composition of the foam precursor includes a primary plasticizer weight percent representative of the primary plasticizer included in the foam precursor and a secondary plasticizer weight percent representative of the one or more secondary plasticizers included in the foam precursor, wherein the primary plasticizer weight percent is greater than the secondary plasticizer weight percent, and wherein the primary plasticizer weight percent and the secondary plasticizer weight percent are each greater than zero.

7. The foam precursor of claim 6, wherein the polysaccharide weight percent is greater than the primary plasticizer weight percent.

8. The foam precursor of claim 1, wherein the foam precursor includes a primary plasticizer, wherein the composition of the foam precursor includes a primary plasticizer weight percent representative of the primary plasticizer included in the foam precursor, and wherein the polysaccharide weight percent is greater than the primary plasticizer weight percent.

9. The foam precursor of claim 8, wherein the primary plasticizer weight percent is from 5% to 20%.

10. The foam precursor of claim 1, wherein the foam precursor is a solid at room temperature, wherein the foam precursor includes a water weight percent representative of water included in the foam precursor, and wherein the polysaccharide weight percent is greater than the water weight percent.

11. A foam, comprising:
a starch, wherein the starch is at least 25% by weight amylose content;
a lubricant; and
a linear polysaccharide different from the starch, wherein a density of the foam is from 0.01 g/cm³ to 0.5 g/cm³, wherein a composition of the foam includes a starch weight percent representative of the starch included in the foam and a polysaccharide weight percent representative of the linear polysaccharide included in the foam, and wherein the starch weight percent is greater than the polysaccharide weight percent.

12. The foam of claim 11, wherein the linear polysaccharide includes chitosan, the starch includes pea starch, and the lubricant includes glycerol monostearate.

13. The foam of claim 11, wherein the composition of the foam includes a lubricant weight percent representative of the lubricant included in the foam, wherein the lubricant weight percent is from about 2% to about 4%.

14. The foam of claim 11, wherein the composition of the foam includes a lubricant weight percent representative of the lubricant included in the foam, wherein the lubricant weight percent is less than the polysaccharide weight percent.

15. The foam of claim 11, wherein the foam further includes at least one of a primary nucleator, one or more secondary nucleators different from the primary nucleator, a primary plasticizer, or one or more secondary plasticizers different from the primary plasticizer, wherein the primary nucleator includes at least one of calcium carbonate or talc, and wherein the primary plasticizer includes at least one of sorbitol, urea, or glycerol.

16. The foam of claim 11, wherein the foam further includes a primary plasticizer and one or more secondary plasticizers different from the primary plasticizer, wherein the composition of the foam includes a primary plasticizer weight percent representative of the primary plasticizer included in the foam and a secondary plasticizer weight percent representative of the one or more secondary plasticizers included in the foam, wherein the primary plasticizer weight percent is greater than the secondary plasticizer weight percent, and wherein the primary plasticizer weight percent and the secondary plasticizer weight percent are each greater than zero.

17. The foam of claim 16, wherein the polysaccharide weight percent is greater than the primary plasticizer weight percent, wherein the primary plasticizer weight percent is from 5% to 20%.

18. A method, comprising:
inputting a first mixture of solid materials into an extruder having a plurality of temperature-controlled zones, wherein the first mixture includes a starch and a lubricant, wherein the starch is at least 25% by weight amylose content;
inputting a second mixture including a linear polysaccharide different from the starch included in the first mixture into the extruder;
forming a first blend by mixing at least the first mixture and the second mixture together as the first mixture and the second mixture propagate through the plurality of temperature-controlled zones; and
outputting the first blend as a first extrudate from the extruder, the first extrudate corresponding to a foam precursor, wherein a composition of the foam precursor includes a starch weight percent representative of the starch included in the foam precursor and a polysaccharide weight percent representative of the linear polysaccharide included in the foam precursor, wherein the starch weight percent is greater than the polysaccharide weight percent, and wherein a first density of the foam precursor is from 0.5 g/cm³ to 1.5 g/cm³.

19. The method of claim 18, further comprising:
chopping the foam precursor to form a plurality of granules;
inputting the plurality of granules into the extruder;
forming a second blend by mixing the plurality of granules together as the plurality of granules propagate through the plurality of temperature-controlled zones; and
outputting the second blend as a second extrudate from the extruder, the second extrudate corresponding to a foam, wherein the first density of plurality of granules is greater than a second density of the foam.

20. The method of 18, wherein the linear polysaccharide includes chitosan, the starch includes pea starch, and the lubricant includes glycerol monostearate.
